(19) United States
(12) Patent Application Publication
(10) Pub. No.: US 2011/0290126 A1
(43) Pub. Date: Dec. 1, 2011

(54) MULTIPOINT SERVO PRESS MACHINE

(75) Inventors: Takao Ito, Sagamihara (JP); Takashi Koshimizu, Sagamihara (JP); Hiroshi Nagase, Sagamihara (JP)

(73) Assignee: AIDA ENGINEERING, LTD., Kanagawa (JP)

(21) Appl. No.: 13/114,202

(22) Filed: May 24, 2011

(30) Foreign Application Priority Data
May 25, 2010 (JP) 2010-119508
Apr. 6, 2011 (JP) 2011-084798

(51) Int. Cl. B30B 1/00

(52) U.S. Cl. 100/280

(57) ABSTRACT

The invention provides a servo press machine including a slide moved up and down by multiple crank structures, the machine which provides perfect synchronism between main gears driving the respective crank structures and in which a compact, efficient power transmission structure can be implemented in a simple construction. In the servo press machine including the slide moved up and down by the multiple crank structures, synchronous distribution gears are driven by servo motors; the multiple main gears are driven in synchronism by the synchronous distribution gears; and each of the crank structures is driven by each of the main gears.

### BACKGROUND OF THE INVENTION

1. Field of the Invention

The present invention relates to a servo press machine and more particularly, to a large servo press machine adapted for pressing with multiple points.

2. Description of Related Art

The servo press machine driven by a servo motor is capable of making various slide motions, which are utilized for various purposes. For example, the servo press machine may slow down the slide motion just prior to press load thereby facilitating drawing or may slow down the slide motion during press load thereby reducing noises. Further, the servo press machine contributes to productivity enhancement by working in a so-called pendular operating mode wherein a slide is moved up and down near a bottom dead point thereof. The large servo press machine adopts a multipoint drive method of pressing the slide with multiple points. Accordingly, the servo press machine employs a system wherein main gears for driving respective points are directly interconnected or indirectly mechanically interconnected via gear so as to drive the pressure points in synchronism. The multipoint servo press is reduced to practice by directly or indirectly driving the main gears by means of the servo motor.

### SUMMARY OF INVENTION

JP-A No. 2004-17089 discloses an embodiment of a large servo press using two motors. In the two point press machine, the main gears are directly interconnected or otherwise indirectly interconnected by means of an intermediate gear.

Further, U.S. Pat. No. 7,102,316 discloses an arrangement wherein the main gears are indirectly interconnected by means of an exclusive intermediate gear for synchronization.

Although such connection methods can distribute force no the two pressure points (crank structures), the following problem is encountered in a case where the individual points do not receive the same load due to eccentric load or the like. If the main gears bear different torques (loads) from the respective points of the system wherein the main gears are interconnected by means of the exclusive intermediate gear for synchronization, the torque difference is born by the intermediate gear interconnecting the main gears. In this case, the main gears are affected by tooth backlash of the gear interconnecting the main gears. Since the number of gears is increased by interposing the intermediate gear, the total sum of gear backlash is increased, causing delay in torque transmission. This leads to a transient delay in the transmission of the load difference between the points so that precision alignment between the two points cannot be ensured (levelness of the slide is not obtained). There is another problem that the need for adding the exclusive intermediate gear for synchronization results in a corresponding increase in torque loss and also in an increased size of the machine.

In the system wherein the main gears are connected to each other for synchronization, on the other hand, the main gears have a great diameter and hence have a great amount of elongation associated with temperature rise. In the light of the great elongation, therefore, a large gear clearance is provided such as to allow the gears to make smooth meshing engagement. This results in a problem of further increase in the backlash.

What is more, the following problem exists in a system wherein only one of the main gears is driven by the servo motor to transmit torque to the other main gear. The one gear is increased in gear width because it first receives the total drive torque. Specifically, the one main gear receives an amount of torque to be consumed by its own crank mechanism and an amount of torque to deliver to the other main gear so that the one main gear has a face with twice as large as that of the other main gear. As a result, the gear is increased in size.

In view of the above problems, it is an object of the present invention to provide a multipoint servo press machine including a slide moved up and down by multiple points, the press machine which provides perfect synchronization between the main gears driving respective crank mechanisms and which permits an efficient and compact power transmission structure to be implemented in a simple construction.

In the multipoint servo press machine including the slide moved up and down by multiple crank structures, a multipoint servo press machine according to the invention is reduced to practice by directly transmitting torque from a torque source (servo motor) to a distribution mechanism (synchronous distribution gear), and directly transmitting the torque from the distribution mechanism to respective main gears constituting the respective crank structures while simultaneously synchronizing the main gears by means of the distribution mechanism.

In a multipoint servo press machine including a slide moved up and down by multiple crank structures according to an aspect of the invention for achieving the above object, the multipoint servo press machine comprises a synchronous distribution gear driven by a servo motor and multiple main gears driven in synchronism by the synchronous distribution gear, and is characterized in that each of the crank structures is driven by each of the main gears.

According to another aspect of the invention, the above multipoint servo press machine is characterized in that the synchronous distribution gear is driven by at least one servo motor; and the multiple main gears are driven by the synchronous distribution gear.

According to still another aspect of the invention, the above multipoint servo press machine is characterized in that the synchronous distribution gears are driven by two servo motors; one of the main gears is driven by the synchronous distribution gear driven by one of the servomotors; the other main gear is driven by the synchronous distribution gear driven by the other servo motor; and the synchronous distribution gears are connected in synchronism.

According to still another aspect of the invention, the above multipoint servo press machine is characterized in that the main gear includes two gears; the synchronous distribution gear includes a large synchronous distribution gear meshed with a drive gear of the servo motor, a first small synchronous distribution gear rotated in synchronism with the large synchronous distribution gear, and a second small synchronous distribution gear meshed with the first small synchronous distribution gear; the first small synchronous distribution gear is meshed with one of the main gear pair to transmit torque thereto while the second small synchronous distribution gear is meshed with the other one of the main gear pair to transmit torque thereto; and the paired main gears are synchronized by meshing engagement between the first and second small synchronous distribution gears.

According to still another aspect of the invention, the above multipoint servo press machine is characterized in that the servo motor and the main gear include two motors and two gears, respectively; the synchronous distribution gear includes a first large synchronous distribution gear and a second large synchronous distribution gear meshed with respective drive gears of the servo motors, a first small synchronous distribution gear rotated in synchronism with the first large synchronous distribution gear, and a second small synchronous distribution gear rotated in synchronism with the second large synchronous distribution gear; the first small synchronous distribution gear is meshed with one of the main gear pair to transmit toque thereto while the second small synchronous distribution gear is meshed with the other one of the main gear pair to transmit toque thereto; and the paired main gears are synchronized by meshing engagement between the first and second small synchronous distribution gears.

According to still another aspect of the invention, the above multipoint servo press machine is characterized in that the servo motor and the main gear include two motors and two gears, respectively; the synchronous distribution gear includes a first large synchronous distribution gear and a second large synchronous distribution gear meshed with respective drive gears of the servo motors, a first small synchronous distribution gear rotated in synchronism with the first large synchronous distribution gear and a second small synchronous distribution gear rotated in synchronism with the second large synchronous distribution gear; the first small synchronous distribution gear is meshed with one of the main gear pair to transmit toque thereto while the second small synchronous distribution gear is meshed with the other one of the main gear pair to transmit toque thereto; and the paired main gears are synchronized, by meshing engagement between the first and second large synchronous distribution gears.

According to still another aspect of the invention, the above multipoint servo press machine is characterized in that the servo motor includes a plurality of servo motors connected to a drive shaft of the drive gear.

According to still another aspect of the invention, the above multipoint servo press machine is characterized in that the servo motor includes a plurality of servo motors connected to the opposite sides of the drive gear.

According to still another aspect of the invention, the above multipoint servo press machine is characterized in that the servo motor includes a plurality of servo motors connected to one side of the drive gear.

According to still another aspect of the invention, the above multipoint servo press machine is characterized in that the plurality of servo motors connected to the one side of the drive gear are housed in the same frame.

### ADVANTAGEOUS EFFECTS OF INVENTION

The servo press machine incorporating the power transmission mechanism of the invention is adapted to reduce the gear backlash because the machine can utilize the synchronous distribution gear for synchronizing the main gears while directly applying the torque to the individual main gears. The gear backlash is small as the result of elimination of the exclusive gear for synchronization and hence, the machine surfers less decrease in positional precision for the slide, achieving good response. Further, the machine can drive by means of a small number of gears and hence, the machine has a simple structure and low loss. Further, the machine can be downsized and is accordingly reduced in inertia moment so as to be capable of high speed response.

### BRIEF DESCRIPTION OF DRAWINGS

FIG. 1 is a basic configuration diagram illustrating the basic principle of the present invention;

FIG. 2 is a configuration diagram of an embodiment 1 of the invention;

FIG. 3 is a sectional view of the embodiment 1 of the invention;

FIG. 4 is a configuration diagram of an embodiment 2 of the invention;

FIG. 5 is a top plan view of the embodiment 2 of the invention;

FIG. 6 is a diagram showing a configuration of a control system of the embodiment 2 of the invention;

FIG. 7 is a configuration diagram of an embodiment 3 of the invention; and

FIG. 8A, FIG. 8B and FIG. 8C are top plan views of the embodiment 3 of the invention.

### DETAILED DESCRIPTION OF THE INVENTION

The embodiments of the present invention will be described as below with reference to the accompanying drawings.

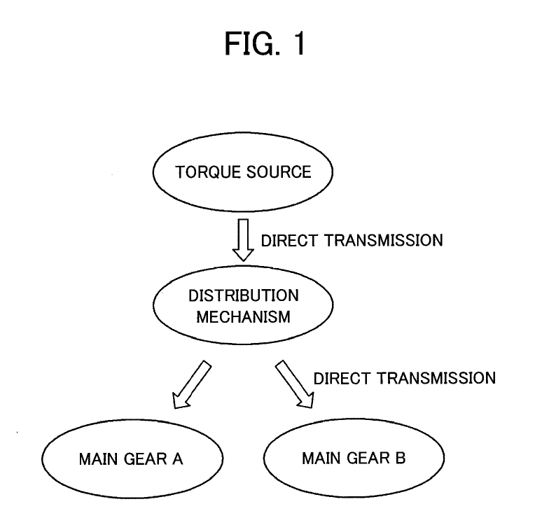

FIG. 1 is a basic configuration diagram illustrating the basic principle of the present invention. The invention addresses a large press machine including multiple pressure points. The press machine has a configuration wherein a torque from a torque source (servo motor) is directly transmitted to a distribution mechanism (synchronous distribution gear) which transmits the torque directly to a main gear A and a main gear B constituting respective crank mechanisms, while simultaneously synchronizing the two main gears. The press machine can solve the above-described problems by adopting such a configuration.

### Embodiment 1

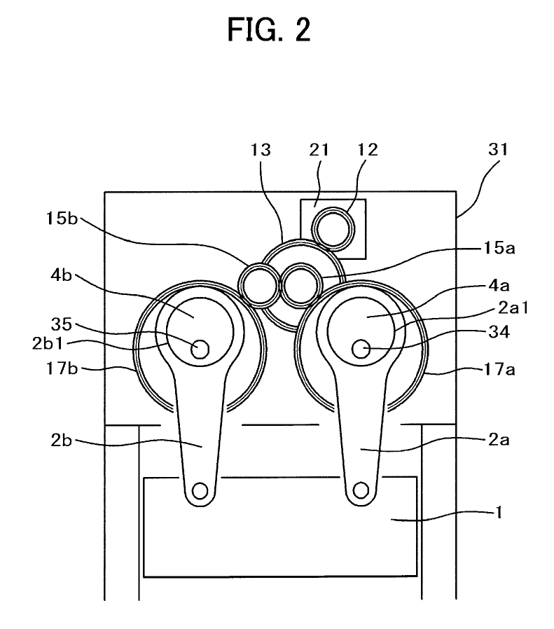

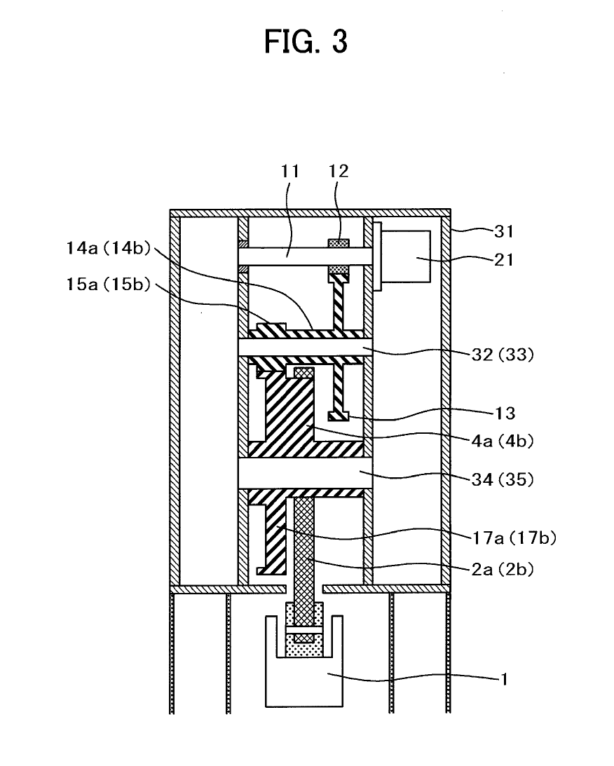

An exemplary configuration of a servo press according to an embodiment 1 practicing the principle of FIG. 1 is shown in FIG. 2 and FIG. 3. The figures schematically depict relevant parts of the embodiment of the invention. The figures show a structure of an eccentric press.

A servo motor 21 is mounted to a frame 31 of the servo press machine. An output shaft of the servo motor 21 is coupled to a drive shaft 11. A drive gear 12 is mounted to the drive shaft 11. The frame 31 is provided with a pin 32, the opposite ends of which are fixed to the frame 31. The pin 32 is engaged with a synchronous distribution shaft 14a, to which a large synchronous distribution gear 13 and a small synchronous distribution gear (first small synchronous distribution gear) 15a are mounted. The small synchronous distribution gear 15a and the large synchronous distribution gear 13 are integrally formed so as to be rotated in synchronism. The large synchronous distribution gear 13 is meshed with the drive gear 12 for torque transmission.

The frame 31 is further provided with a pin 33, the opposite ends of which are fixed to the frame 31. The pin 33 is engaged with a synchronous distribution shaft 14b, to which a small synchronous distribution gear (second small synchronous distribution gear) 15b is mounted. The small synchronous distribution gear 15b is meshed with the above small synchronous distribution gear 15a for torque transmission.

The frame 31 is provided with a pin 34, the opposite ends of which are fixed to the frame 31. The pin 34 is engaged with an eccentric ring 4a, to which a main gear 17a is fixed. The main gear (one of the main gear pair) 17a is meshed with the small synchronous distribution gear 15a. The eccentric ring 4a rotates in synchronism with the main gear 17a.

The frame 31 is further provided with a pin 35, the opposite ends of which are fixed to the frame 31. The pin 35 is engaged with an eccentric ring 4b, to which a main gear 17b is fixed. The main gear (the other one of the main gear pair) 17b is meshed with the small synchronous distribution gear 15b. The eccentric ring 4b rotates in synchronism with the main gear 17b.

An eccentric portion of the eccentric ring 4a engages with a hole 2a1 in a large diameter portion of a con rod 2a, a lower end of which is coupled to a slide 1. Further, an eccentric portion of the eccentric ring 4b engages with a hole 2b1 in a large diameter portion of a con rod 2b, a lower end of which is coupled to the slide 1.

The slide 1 makes an up-down motion as supported at two points defined by a crank mechanism comprising the eccentric ring 4a and the con rod 2a and a crank mechanism comprising the eccentric ring 4b and the con rod 2b. That is, the slide is moved up and down by crank structures driven by the rotation of the main gears 17a, 17b.

In the above-described configuration, the torque of the servo motor 21 is directly transmitted to the main gears 17a, 17b via the synchronous distribution gears 13, 15a, 15b while the main gears 17a, 17b are synchronized by means the small synchronous distribution gears 15a, 15b. Namely, the small synchronous distribution gears 15a, 15b serve a dual purpose of transmitting the torque to the main gears and synchronizing the main gears. Thus is eliminated the need for an exclusive gear for synchronizing the main gears. Such a configuration permits the right and left main gears 17a, 17b to be synchronized, or namely, permits pressure points of the slide to be moved up and down in synchronism.

The main gears 17a, 17a are freely driven into rotations through normal rotation, reverse rotation and variable speed control of the servo motor 21. Hence, the main gears can be freely set for a variety of slide motions which include not only the slide motion by the crank mechanism but also slide motions other than that by the crank mechanism, accelerated and decelerated motions including a motionless state that are suited for forming processes, and normal and reverse pendulum motions. The main gears can be set for any combinations of these slide motions or switched between these slide motions. This makes it possible to increase forming precisions for press formed articles and to enhance productivity and adaptability thereof. Examples of a motor usable as the servo motor 21 include a synchronous motor employing permanent magnet, a synchronous motor employing coil field, an induction motor, a reluctance motor and the like.

Further, the synchronous motors are not limited to such AC motors but may also include DC motors. The description is made herein on the assumption that the servo motor 21 is a permanent magnet synchronous motor. While FIG. 2 illustrates the crank mechanism comprising the eccentric press, the crank mechanism may also comprise a crank shaft. The power transmission structure of the embodiment is also applicable to other mechanisms than the crank mechanism, which include a link press, a knuckle press and the like. According to the invention, all kinds of structures that employ such a configuration for moving up and down the slide are referred to as the “crank structure”. While the embodiment illustrates the configuration employing the two con rods 2a, 2b, a structure may be made such that each of the pressure points is pressed by more than one con rod.

In a case where the limited capacity of the motor or a required pressing force of the press machine dictates the need for adding some motors, the large synchronous distribution gear 13 may be meshed with another servo motor equipped with a drive gear or otherwise, two or more servo motors may be connected to the output shaft of the servo motor 21.

The servo press machine employing the power transmission mechanism of the embodiment can drive the slide by directly applying the torque to the main gears by means of the small synchronous distribution gears, while simultaneously providing perfect synchronism between the main gears constituting the respective crank mechanisms by meshing their associated small synchronous distribution gears with each other. Since an exclusive gear for the meshing engagement of the main gears is dispensed with, the machine can attain effects of reducing the number of gears and thence backlash, reducing the deterioration of the positional precision for the slide and achieving good response. Furthermore, the main gears are synchronized by meshing together the small synchronous distribution gears having the small diameter such as to be less deformed by thermal expansion. Hence, the backlash can be reduced. In addition, the main gears being driven are synchronized by the small synchronous distribution gears. Therefore, even if one of the main gears is increased in load, the backlashes between the main gear and small synchronous distribution gear and between the small synchronous distribution gears are small.

The press machine can drive by means of a small number of gears because the exclusive gear for the meshing engagement of the main gears is dispensed with. Therefore, the machine has a simple structure and small loss. Further, the machine can be downsized and is accordingly reduced in inertia moment so as to be capable of high response drive.

### Embodiment 2

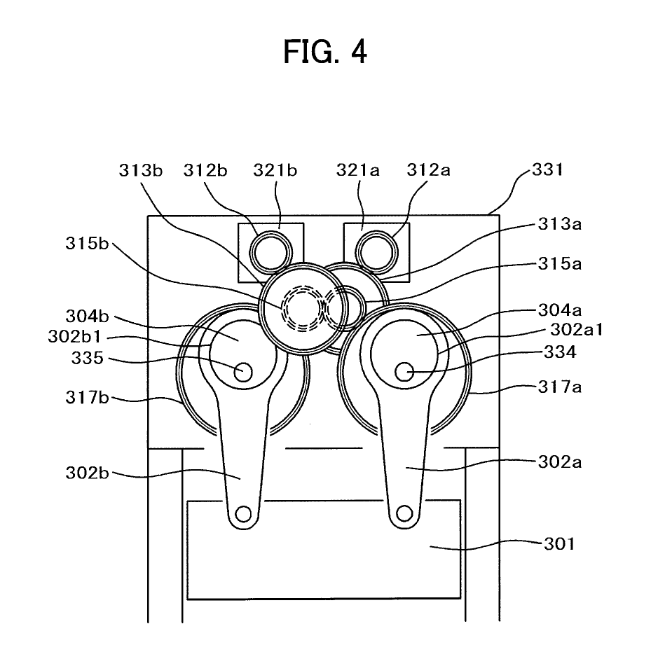

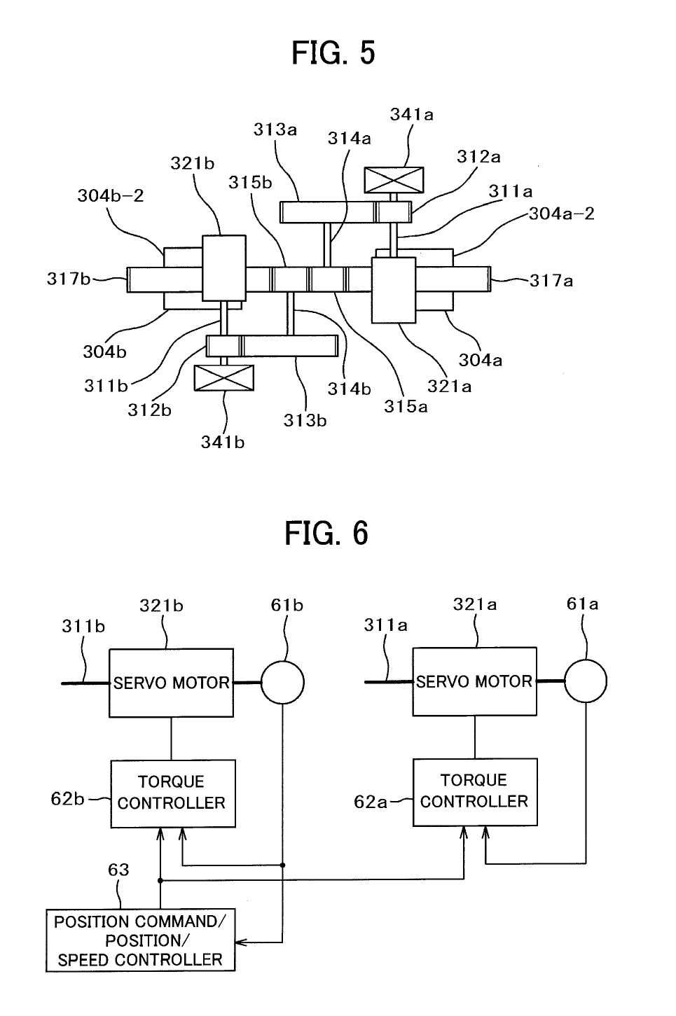

FIG. 4 and FIG. 5 are configuration diagrams illustrating an embodiment 2 of the invention. The embodiment is of a two-point support type and each of the points is driven by two con rods. FIG. 4 is a schematic front view of the embodiment while FIG. 5 is a schematic top plan view thereof.

A servo motor 321a is mounted to a frame 331 of a servo press machine. An output shaft of the servomotor 321a is coupled to a drive shaft 311a, to which a drive gear 312a is mounted. The frame 331 is provided with a pin 332 (not shown), the opposite ends of which are fixed to the frame 331. The pin 332 is engaged with a synchronous distribution shaft 314a. Mounted so the synchronous distribution shaft 314a are a large synchronous distribution gear (first large synchronous distribution gear) 313a and a small synchronous distribution gear (first small synchronous distribution gear) 315a. The large synchronous distribution gear 313a is meshed with the above drive gear 312a.

A pin 334 is fixed to the frame 331 at opposite ends thereof. The pin 334 is engaged with eccentric rings 304a and 304a-2. The eccentric rings 304a and 304a-2 are fixed to opposite sides of a main gear 317a so as to be rotated in synchronism with the main gear 317a. The main gear (one of the main gear pair) 317a is meshed with the above small synchronous distribution gear 315a.

An eccentric portion of the eccentric ring 304a engages with a hole 302a1 in a large diameter portion of a con rod 302a. A lower end of the con rod 302a is coupled to a slide 301. An eccentric portion of the eccentric ring 304a-2 engages with a hole in a large diameter portion of a con rod 302a-2 (not shown). A lower end of the con rod 302a-2 is coupled to the slide 301.

A servo motor 321b is mounted to the frame 331. An output shaft of the servomotor 321b is coupled to a drive shaft 311b, to which a drive gear 312b is mounted. The frame 331 is provided with a pin 333 (not shown), the opposite ends of which are fixed to the frame 331. The pin 333 is engaged with a synchronous distribution shaft 314b. Mounted to the synchronous distribution shaft 314b are a large synchronous distribution gear (second large synchronous distribution gear) 313b and a small synchronous distribution gear (second small synchronous distribution gear) 315b. The large synchronous distribution gear 313b is meshed with the above drive gear 312b.

The frame 331 is further provided with a pin 335, the opposite ends of which are fixed to the frame 331. The pin 335 is engaged with eccentric rings 304b and 304b-2. The eccentric rings 304b and 304b-2 are fixed to opposite sides of a main gear 317b so as to be rotated in synchronism with the main gear 317b. The main gear (the other one of the main gear pair) 317b is meshed with the above small synchronous distribution gear 315b. An eccentric portion of the eccentric ring 304b engages with a hole 302b1 in a large diameter portion of a con rod 302b. A lower end of the con rod 302b is coupled to the slide 301. An eccentric portion of the eccentric ring 304b-2 engages with a hole in a large diameter portion of a con rod 302b-2 (not shown). A lower end of the con rod 302b-2 is coupled to the slide 301. The small synchronous distribution gear 315a and the small synchronous distribution gear 315b are meshed with each other so as to be synchronized.

As described above, a crank mechanism is constituted by the eccentric ring 304a and the con rod 302a while a crank mechanism is constituted by the eccentric ring 304a-2 and the con rod 302a-2 (not shown). Further, a crank mechanism is constituted by the eccentric ring 304b and the con rod 302b while a crank mechanism is constituted by the eccentric ring 304b-2 and the con rod 302b-2 (not shown). The slide 301 is moved up and down by these crank mechanisms. Namely, the slide is moved up and down by the motion of the crank structures driven by the main gears 317a and 317b. That is, the embodiment adopts a two-point drive system wherein the individual points are driven by the respective pairs of con rods disposed on the opposite sides of the main gears 317a and 317b.

In this embodiment, a mechanical brake assembly is provided, for holding the slide in stop position or for bringing the machine to emergency stop. A mechanical brake assembly 341a is connected to the drive shaft 311a of the servo motor 321a, while a mechanical brake assembly 341b is connected to the drive shaft 311b of the servo motor 321. In an alternative arrangement to that shown in FIG. 5, the brake assembly may also be disposed on the opposite side from the load of the output shaft of the motor (coupled to the drive shaft) or may also be disposed on the synchronous distribution shaft.

According to the embodiment as shown in FIG. 5, the servo motors 321a and 321b, the large synchronous distribution gears 313a and 313b, the drive gears 312a and 312b and the break assemblies 341a and 341b are disposed in symmetric relation with respect to a point defined by a gear mesh contact between the small synchronous distribution gears 315a and 315b. The eccentric rings 304 are fixed to the opposite sides of the main gear 317. Hence, the mechanism assembled to the frame 331 has its centroid located near the center (middle) of the machine, permitting the slide 301 to be driven by the two con rods in a well-balanced manner. The servo press machine is less likely to encounter torsion even if the machine is impacted during this driving operation.

According to the above embodiment, the servo motors 321a and 321b are assembled in the frame 331. From the viewpoint of a press structure, mounting these servo motors atop the frame 331 is equivalent to assembling them in the frame.

FIG. 6 is a block, diagram showing an exemplary configuration of a control system in a case where two servo motors are employed. Referring to the figure, an encoder 61a for detecting a rotational position of the motor is connected to an end of the shaft of the servo motor 321a, while an encoder 61b for detecting a rotational position of the servomotor 321b is connected to an end of the shaft of the servo motor 321b. The encoder 61b inputs a rotation signal to a position command/position/speed controller 63. The drive shaft 311b connected with the encoder 61b serves as a master shaft such that the rotational position and the rotational speed of the servo motor 321a and the rotational position and the rotational speed of the servo motor 321b are controlled.

The position command/position/speed controller 63 calculates a position/speed of the motor from a position command for the slide so as to generate a position command for the motor on a moment-to-moment basis, and controls the position/speed of the motor based on this position command for the motor. This controller calculates and outputs the same torque command to the respective servo motors. The position command/position/speed controller 63 inputs the torque command to a torque controller 62 (62a, 62b) for driving the respective motors.

The torque controllers 62a, 62b are configured the same way and control a current flow through the respective motors in response to the torque command. According to the torque command, the torque controller 62 comprises a current command generator, a current controller, a PWM controller, a power controller comprising a power semiconductor device, a current detector for detecting a current flow through the motor and the like. A specific configuration of the torque controller is well known and hence, the description thereof is omitted.

A signal from the encoder 61 (61a, 61b) is also used as a signal for detecting a magnetic pole position of the respective motors and is inputted to a corresponding torque controller 62a, 62b.

Such a configuration provides for the implementation of master/slave drive using the drive shaft 311b as the master shaft and the drive shaft 311a as a slave shaft. This permits the position and speed of the slide to be controlled with the respective motors operating in a well-balanced manner to output the same torque.

In the servo press machine employing the power transmission mechanism of the embodiment, the motors drive their respective synchronous distribution gears while the synchronous distribution gears drive their respective main gears and are simply meshed with each other whereby the main gears constituting the respective crank mechanisms can drive the slide as operating in perfect synchronism.

Since the exclusive gear for the meshing engagement of the main gears is dispensed with, the machine attains effects of reducing the number of gears and thence backlash, reducing the deterioration of the positional precision for the slide and achieving good response. Furthermore, the backlash can be reduced further because the main gears are synchronized by meshing engagement of the small synchronous distribution gears having a small diameter so as to be less deformed by thermal expansion. Since the main gears, being driven, are synchronized by the small synchronous distribution gears, the backlash between the main gear and the small synchronous distribution gear and the backlash between the small synchronous distribution gears are small if one of the main gears is increased in load. That is, the influence of backlash can be reduced because the torque is complemented by a small number of gears meshed with each other.

Since the small synchronous distribution gears are meshed with each other for synchronizing the main gears, the main gears together with their crank mechanisms can be disposed in closely spaced relation. Thus, the servo press machine can be made compact.

The main gear is subject to a torque from just one motor and thence, has a small duty. Further, the machine can drive by means of a small number of gears and hence, the machine has a simple structure and low loss. Further, the machine can be downsized and is accordingly reduced in inertia moment so as to be capable of high response drive.

The embodiment illustrates a structure suited to be driven by multiple motors and is applicable to a larger servo press than that of the embodiment 1. In the case where the limited capacity of the motor or a required pressing force of the press machine dictates the need for adding some motors, the large synchronous distribution gears 313a, 313b in FIG. 4 may be meshed with additional servo motors equipped with drive gears or otherwise, two or more servo motors may be connected to the output shafts of the servo motors 321a, 321b just as in the embodiment 1.

### Embodiment 3

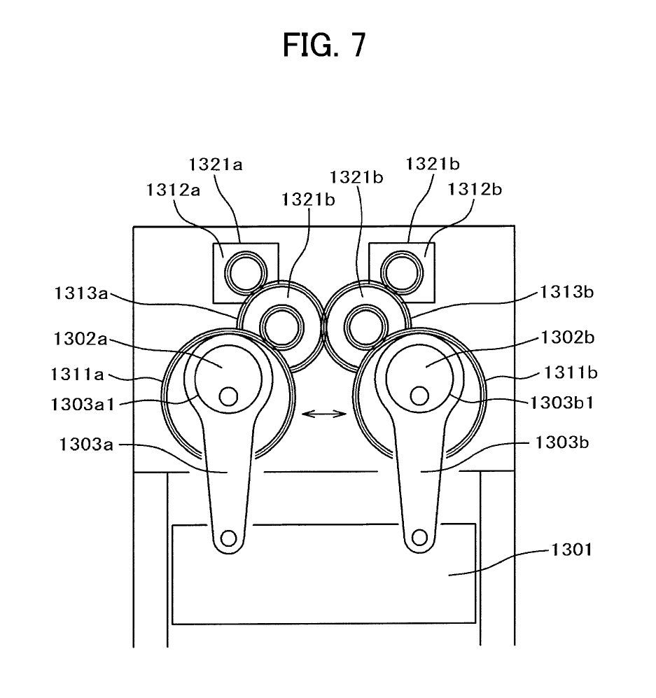

FIG. 7 is a configuration diagram of an embodiment 3 of the invention. The configuration differs from that of the embodiment 2 in the manner of meshing engagement of the synchronous distribution gears for synchronizing the main gears.

An eccentric portion of an eccentric ring 1302a engages with a hole 1303a1 in a large diameter portion of a con rod 1303a. A lower end of the con rod 1303a is coupled to a slide 1301. An eccentric portion of an eccentric ring 1302b engages with a hole 1303b1 in a large diameter portion of a con rod 1303b. A lower end of the con rod 1303b is coupled to the slide 1301. The eccentric rings 1302a, 1302b are connected to a main gear 1311a (one of the main gear pair) and a main gear 1311b (the other one of the main gear pair) at one end thereof, respectively.

The main gear 1311a is meshed with a small synchronous distribution gear (first small synchronous distribution gear) 1314a. Connected to a shaft of this synchronous distribution gear is a large synchronous distribution gear (first large synchronous distribution gear) 1313a which is meshed with a drive gear 1312a. The drive gear 1312a is connected to a servo motor group 1321a. On the other hand, the main gear 1311b is meshed with a small synchronous distribution gear (second small synchronous distribution gear) 1314b. Connected to a shaft of this synchronous distribution gear is a large synchronous distribution gear (second large synchronous distribution gear) 1313b which is meshed with a drive gear 1312b. The drive gear 1312b is connected to a servo motor group 1321b.

The large synchronous distribution gears 1313a and 1313b are in meshing engagement whereby synchronous connection between the main gears 1311a and 1311b is established. In this manner, the right and left main gears 1311a, 1311b are driven in synchronism by the respective servo motor groups 1321a and 1321b. In the illustrated example, the main gears 1311a and 1311b rotate in the opposite directions. As will be described hereinlater, the servo motor groups 1321a, 1321b each include more than one motor mounted to the same shaft.

The embodiment has the configuration wherein the large synchronous distribution gears 1313a and 1313b are meshed with each other in order that the torque from the motor drive shaft drives the main gears 1311a, 1311b as decelerated by two-stage synchronous distribution gears. Therefore, a distance between the con rods 1303a and 1303b can be defined freely so that the degree of design freedom is increased as compared to the configuration of the embodiment 2 (FIG. 4).

The large synchronous distribution gears 1313a and 1313b are in meshing engagement thereby increasing a distance between the center of the large synchronous distribution gears and a distance between the center of the small synchronous distribution gears 1314a, 1314b as compared to the embodiment 2. Also increased is a distance between the main gears 1311a, 1311b meshed with the small synchronous distribution gears which are increased in the distance therebetween. In directions of arrows in the figure, there is provided a large margin of adjustment for the distance between the main gears 1311a, 1311b with the small synchronous distribution gears 1314a, 1314b meshed therewith. Therefore, an allowable margin of adjustment for the distance between the con rods 1303a and 1303b can be increased.

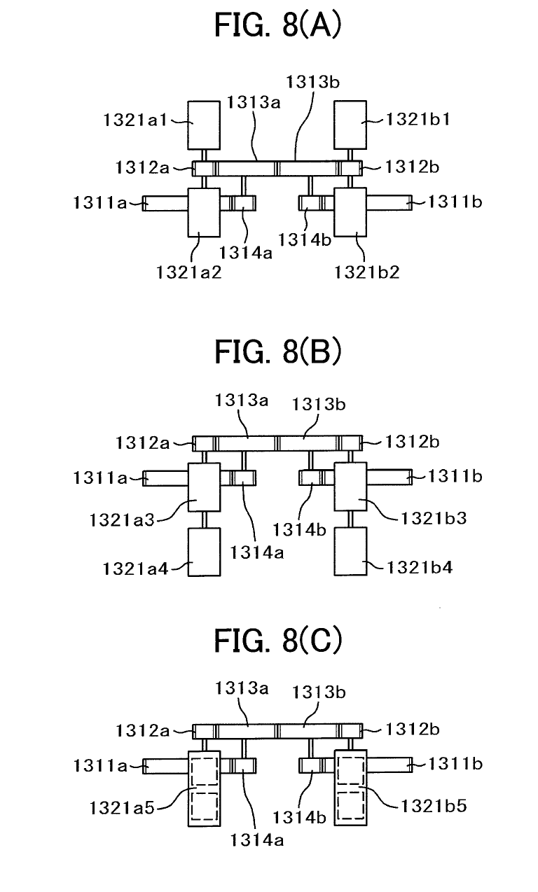

FIG. 8A, FIG. 8B and FIG. 8C illustrate examples of a specific configuration of motor connection. The same reference characters as those in FIG. 7 refer to the corresponding gears.

The servo motor group 1321a shown in FIG. 8A and FIG. 8B includes two servo motors connected to the same motor drive shaft. The servomotor group 1321b includes two servo motors connected to the same motor drive shaft.

FIG. 8A illustrates an example where the motors are disposed on the opposite sides of the drive gear 1312a, 1312b. Servomotors 1321a1, 1321a2 are connected to the opposite sides of the drive gear 1312a, while servo motors 1321b1, 1321b2 are connected to the opposite sides of the drive gear 1312b. In this manner, the servo motors are disposed on the opposite sides of the drive gear so that the drive gear is supported by the motor drive shafts on the opposite sides thereof. Therefore, the drive gear can make better balanced rotation than a drive gear supported by a cantilever structure.

FIG. 8B illustrates an example where motors 1321a3, 1321a4 are disposed on one side of the drive gear 1312a while motors 1321b3, 1321b4 are disposed on one side of the drive gear 1312b. Such a configuration permits the motor drive shaft to be shortened.

FIG. 8C illustrates an example where stators and rotors of multiple motors (represented by broken lines in the figure) are housed in the same frame or where motors 1321a5 and 1321b5 of a so-called tandem construction are provided. As shown in the figure, the configuration looks like a 1 motor-driven type. Such a configuration permits further size reduction of the press machine because the motor connection portion is shorter than that of FIG. 8B.

Since the small synchronous distribution gear 1314 is disposed on one side of the large synchronous distribution gear 1313, as shown in FIG. 8A, FIG. 8B and FIG. 8C, the main gear 1311 can be brought from the one side into meshing engagement with the small synchronous distribution gear 1314. Thus, a meshing operation is facilitated.

What is claimed is:

1. A multipoint servo press machine including a slide moved up and down by multiple crank structures, wherein the improvement comprises:
a synchronous distribution gear driven by a servo motor; and
multiple main gears driven in synchronism by the synchronous distribution gear; and
wherein each of the crank structures is driven by each of the main gears.

2. The multipoint servo press machine according to claim 1, wherein
the synchronous distribution gear is driven by at least one servo motor; and the multiple main gears are driven by the synchronous distribution gear.

3. The multipoint servo press machine according to claim 1, wherein
the synchronous distribution gears are driven by two servo motors; one of the main gears is driven by the synchronous distribution gear driven by one of the servo motors; the other main gear is driven by the synchronous distribution gear driven by the other servo motor; and the synchronous distribution gears are connected in synchronism.

4. The multipoint servo press machine according to claim 2, wherein
the main gear includes two gears; the synchronous distribution gear includes a large synchronous distribution gear meshed with a drive gear of the servo motor, a first small synchronous distribution gear rotated in synchronism with the large synchronous distribution gear, and a second small synchronous distribution gear meshed with the first small synchronous distribution gear; the first small synchronous distribution gear is meshed with one of the main gear pair to transmit torque thereto while the second small synchronous distribution gear is meshed with the other one of the main gear pair to transmit torque thereto; and the paired main gears are synchronized by meshing engagement between the first and second small synchronous distribution gears.

5. The multipoint servo press machine according to claim 3, wherein
the servo motor and the main gear include two motors and two gears, respectively; the synchronous distribution gear includes a first large synchronous distribution gear and a second large synchronous distribution gear meshed with respective drive gears of the servo motors, a first small synchronous distribution gear rotated in synchronism with the first large synchronous distribution gear, and a second small synchronous distribution gear rotated in synchronism with the second large synchronous distribution gear; the first small synchronous distribution gear is meshed with one of the main gear pair to transmit toque thereto while the second small synchronous distribution gear is meshed with the other one of the main gear pair to transmit toque thereto; and the paired main gears are synchronized by meshing engagement between the first and second small synchronous distribution gears.

6. The multipoint servo press machine according to claim 3, wherein
the servo motor and the main gear include two motors and two gears, respectively; the synchronous distribution gear includes a first large synchronous distribution gear and a second large synchronous distribution gear meshed with respective drive gears of the servo motors, a first small synchronous distribution gear rotated in synchronism with the first large synchronous distribution gear and a second small synchronous distribution gear rotated in synchronism with the second large synchronous distribution gear; the first small synchronous distribution gear is meshed with one of the main gear pair to transmit toque thereto while the second small synchronous distribution gear is meshed with the other one of the main gear pair to transmit toque thereto; and the paired main gears are synchronized by meshing engagement between the first and second large synchronous distribution gears.

7. The multipoint servo press machine according to claim 3, wherein
the servo motor includes a plurality of servo motors connected to a drive shaft of a drive gear.

8. The multipoint servo press machine according to claim 7, wherein the servo motor includes a plurality of servo motors connected to the opposite sides of the drive gear.

9. The multipoint servo press machine according to claim 7, wherein
the servo motor includes a plurality of servo motors connected to one side of the drive gear.

10. The multipoint servo press machine according to claim 9, wherein
the plurality of servo motors connected to the one side of the drive gear are housed in the same frame.
